(19) United States
(12) Patent Application Publication
(10) Pub. No.: US 2015/0051958 A1
(43) Pub. Date: Feb. 19, 2015

(54) Apparatus and Method for Providing A Computer-Implemented Portable Environment for In-Class Educator Observation

(71) Applicant: School Improvement Network, Midvale, UT (US)

(72) Inventors: Chet D. Linton, Sandy, UT (US); Cory J. Linton, Draper, UT (US); Curtis W. Linton, Salt Lake City, UT (US); Jonathan Smalley, Riverton, UT (US); Neil Jarman, Midvale, UT (US)

(73) Assignee: School Improvement Network, Midvale, UT (US)

(21) Appl. No.: 13/967,003

(22) Filed: Aug. 14, 2013

(51) Int. Cl. G06Q 10/06; G06Q 50/20

(52) U.S. Cl. CPC G06Q 10/06398; G06Q 50/20
USPC 705/7.42

(57) ABSTRACT

A computer-implemented, portable environment for in-class educator observation allows an observer to easily capture and date-stamp the observer's in-class observations of educator performance, and then to easily align such observations to template standards of an observation template, all in a way that allows the observer to focus on capturing details about the educator performance rather than on the data-gathering process.

### RELATED APPLICATIONS

The present application may be related to U.S. patent application Ser. No. 13/840,764, filed Mar. 15, 2013 and titled “Apparatus and Method Providing Computer-Implemented Environment for Improved Educator Effectiveness” and naming Cory J. Linton, Jonathan Smalley, Neil Jarman, James Lyon, Justin Morris, Matthew Donaldson, Jeremy P. Petersen, and Chet D. Linton as inventors, the disclosure of which is incorporated herein, in its entirety, by reference.

### TECHNICAL FIELD

The present invention relates to evaluation of educators, and more particularly to in-class observations of educators.

### BACKGROUND ART

It is known in the prior art to observe a teacher's classroom performance as part of a teacher evaluation process. Typically, an observer will sit in the teacher's classroom and take notes describing the teacher's words and actions, and at a later time the observer will generate a report based on those notes.

If the report is to include an assessment of the teacher's performance based on a rubric, the observer must correlate his observations to the elements of the rubric. Such correlation may require that the observer assess each statement or action by the teacher in real-time (i.e., during the observation, at the time when the teacher makes the statement or takes the action). A given statement or action may apply to a variety of rubric elements, and so the observer may have to mentally run through a list of rubric elements to correlate each statement or action by the teacher to one or more of the rubric elements, resulting in a division of the observer's attention and possibly causing the observer to miss portions of the teacher's performance. Further, such correlations may require a nuanced assessment by the observer of one or more of the rubric elements, further raising the possibility of error when done in real time without access to rubric definitions.

### SUMMARY OF THE EMBODIMENTS

In a first embodiment, there is provided a computer-implemented method of creating documentation of an observation by an observer of an educator, including serving data, over a network, to a mobile computing device of the observer, for display on the mobile computing device, observation-related data (e.g., a listing of a set of educators available for observation and a listing of a set of templates for use in documenting the observation); receiving at the server, over the network, from the mobile computing device of the observer, relative to an observation by the observer of an educator selected on the mobile device, and relative to an observation template, observation data (e.g., including a set of paragraphs), and alignment data that associates at least one item of observation data (e.g., each one of the paragraphs) with at least one corresponding template standard of the observation template, wherein the alignment data and the observation data have been created by the observer on the mobile computing device; and storing by the server in an observation database the observation data, wherein the server stores each one of the paragraphs as a comment in association with the at least one corresponding template standard of the observation template as specified by the alignment data. Some embodiments also include serving data over a network to a mobile computing device including a listing of a set of observations in progress (e.g., observations for which at least one observation paragraph has been stored). Further, in various embodiments, serving data over a network to a mobile computing device also includes serving data including content objectives, wherein each content objective includes information describing a corresponding template standard, such that the observer may optionally access a content objective corresponding to a template standard to facilitate generation, by the user, of alignment data between the template standard and one or more of the paragraphs.

In various embodiments, the observation-related data may include, for example, a set of educators available for observation and a listing of a set of templates for use in documenting the observation, e.g., a template that includes a set of template standards for evaluating a selected educator (which may include at least one user-defined template), a listing of schools, wherein at least one of the schools is a school at which at least one of the educators is available for observation, and other observation parameters.

In various embodiments, the observation data may include a set of paragraphs, and/or photographs, video clips, and audio recordings captured contemporaneously with an observation.

Some embodiments also include template selection data including a specification by the observer of an observation template from the set of templates.

Alignment data may associate an item of observation data with one, or more than one, template standard. Indeed, in some embodiments, at least one template standard may be associated, at any given time, with at least one paragraph and at least one of the audio data, video data, and still-photo data.

In another embodiment, a computer-implemented method of creating documentation of an observation by an observer of an educator, includes receiving on a mobile device, over a network, from a server, observation-related data; displaying on the mobile device the listing of the set of templates, and receiving on the mobile device a selection by the observer of a selected template with respect to which documentation of an observation will be received; displaying on the mobile device the listing of the set of educators, and receiving on the mobile device a selection by the observer of a selected educator with respect to whom documentation of the observation will be received; and receiving on the mobile device a set of inputs from the observer, relative to the observation by the observer of the selected educator, and relative to an observation template, observation data including (e.g., a set of paragraphs; and/or audio data, video data, and still-photo data).

In various embodiments, the observation related data may include, for example, a listing of a set of educators available for observation and a listing of a set of templates for use in documenting the observation, and/or a listing of a set of schools, wherein at least one of the schools is a school at which at least one of the educators is available for observation

The templates listed in the set of templates may include a set of template standards for evaluating a selected educator. Further, at least one of the templates from the list of templates may be a user-defined template.

Some embodiments also include receiving on the mobile device a set of alignment inputs from the observer, the alignment inputs correlating each item of the observation data (e.g., paragraphs, audio data, video data, and still-photo data, which audio data, video data, or still-photo data having been captured by the observer contemporaneously with the creation of the paragraphs) to at least one of a set of template standards. Indeed, some embodiments include communicating the observation data and its corresponding alignment data to the server. Generally, a template standard may be associated, at any given time, with at least one of a paragraph and at least one of the audio data, video data, and still-photo data.

The method may also include recording, as a part of the observation data, time and date data corresponding to each of the set of paragraphs of the observation data, each item of the time and date data indicating the time and date of the creation of the corresponding paragraph.

### BRIEF DESCRIPTION OF THE DRAWINGS

The foregoing features of embodiments will be more readily understood by reference to the following detailed description, taken with reference to the accompanying drawings, in which:

FIG. 1 schematically illustrates an embodiment of a mobile electronic data device;

FIG. 2 schematically illustrates a network environment for use by an electronic data device;

FIGS. 3A-3C schematically illustrate screenshots and organization structure of an embodiment of an observation environment;

FIGS. 4A-4C schematically illustrate screenshots and organization structure of an embodiment of a navigation facility for an observation environment;

FIGS. 5A-5C schematically illustrate a screenshot and organization structure of an embodiment of a facility for accessing various observations within an observation environment;

FIGS. 6A-6E schematically illustrate screenshots and organization structure of an embodiment of an observation parameter specification facility for an observation environment;

FIGS. 7A-7B schematically illustrate screenshots of an embodiment of an evidence capture facility for an observation environment;

FIGS. 8A-8C schematically illustrate screenshots of an embodiment of an evidence alignment facility for an observation environment;

FIGS. 9A and 9B schematically illustrate embodiments of and evaluation facility;

FIG. 10 schematically illustrates a system architecture for an embodiment of an observation system;

FIG. 11 schematically illustrates a block diagram showing logical flow associated with providing educational resources using the system architecture of FIG. 9;

FIG. 12 schematically illustrates a flow chart of an embodiment of a computer-implemented method of creating documentation of an observation by an observer of an educator; and

FIG. 13 schematically illustrates a flow chart of an embodiment of computer-implemented method of creating documentation of an observation by an observer of an educator.

### DETAILED DESCRIPTION OF SPECIFIC EMBODIMENTS

In various embodiments, a computer-implemented, portable environment for in-class educator observation allows an observer to easily capture the observer's in-class observations of educator performance, and then to easily align such observations to template standards of an observation template, all in a way that allows the observer to focus on the observation rather than on the data-gathering process.

For example, a process of evaluating the performance of an educator includes gathering data on the educator's in-class performance (i.e., when the educator is teaching a class). In one embodiment, an observer attends a class being taught by an educator, to acquire performance data relating to the educator's performance by observing the educator teaching a class. The observer brings along an electronic data device such as a laptop computer or tablet, for example, and captures several items of data (i.e., captured evidence) of the educator's performance. Later, the observer may align (or “correlate”) each captured data item to one or more “template standards” associated with a selected template. Because the observer does not need to assess the evidence as it happens, this approach leaves the observer freer to observe the educator and capture evidence.

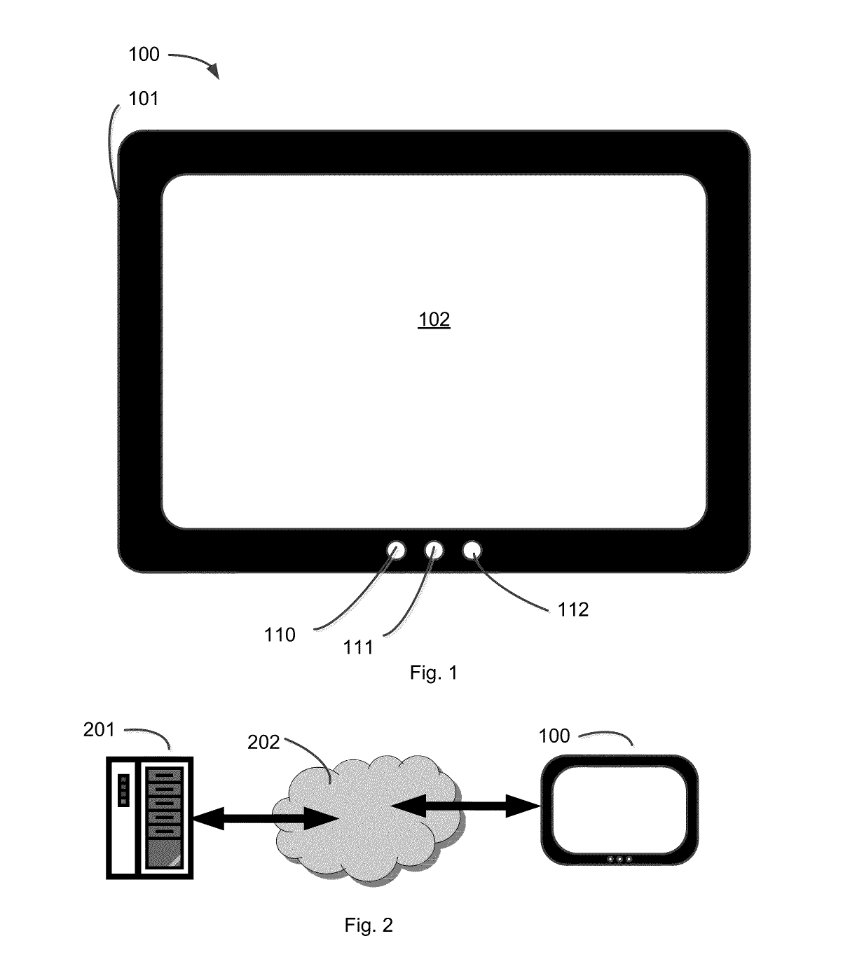

Referring to FIG. 1, in various examples, the observer records an observation session on an electronic data device 100, schematically illustrated as a tablet computer, such as Apple's iPad or Samsung's Galaxy Tab and Galaxy Note products, to name but a few examples. The illustrative electronic data device 100 includes a frame 101 and a display screen 102, configured to display information to the observer and receive input from the observer. To that end, the electronic data device 100 may have a keyboard, such as a virtual keyboard (e.g., displayable on the screen 102) or a hardware keyboard in communication with the screen 102. In various embodiments, the electronic data device 100 may be portable (e.g., a tablet or laptop computer) and so may be referred-to as a “mobile computing device.”

An observer's electronic data device 100 may also be any of a variety of other platforms that allow an observer to capture evidence of an educator's performance, such as a MacBook from Apple, or a Toshiba Satellite laptop, to name but a few examples. An observer's electronic data device 100 may be controlled and operated in ways known by typical computer users, for example by operation of a mouse to click an on-screen icon or control, or by tapping or swiping a screen.

Various platforms may have hardware keyboards, virtual keyboards, a computer mouse, or other hardware or software features to facilitate data entry. For example, the tablet computer 100 of FIG. 1 includes a still-camera 110 for capturing still photographs of an educator in a classroom, a video camera 111 for capturing video (with or without accompanying audio) of an educator in a classroom, and a microphone 112 for capturing audio of an educator in a classroom.

Referring to FIG. 2, in illustrative embodiments, the observer's electronic data device 100 is in bi-directional communication with a server 201 via a network 202. For example, the network 202 may be a school's local area network, or may be the Internet, to name just two examples. The server 201 and observer's electronic data device 100 may exchange information and data, as described in additional detail below.

Navigating and Operating the Environment

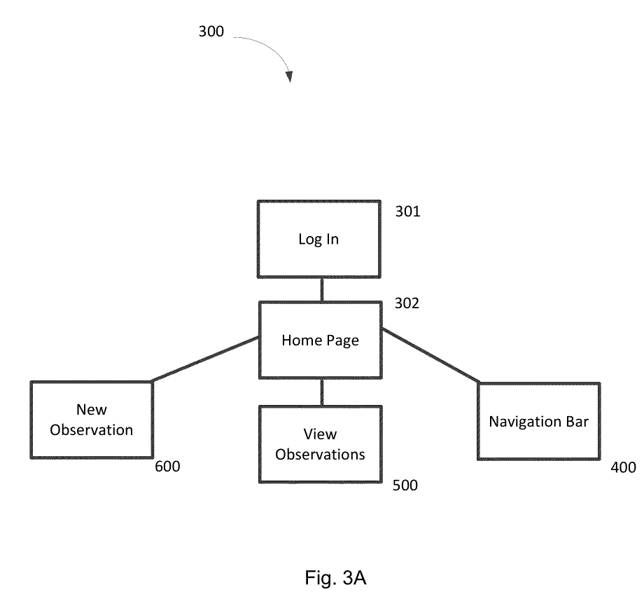

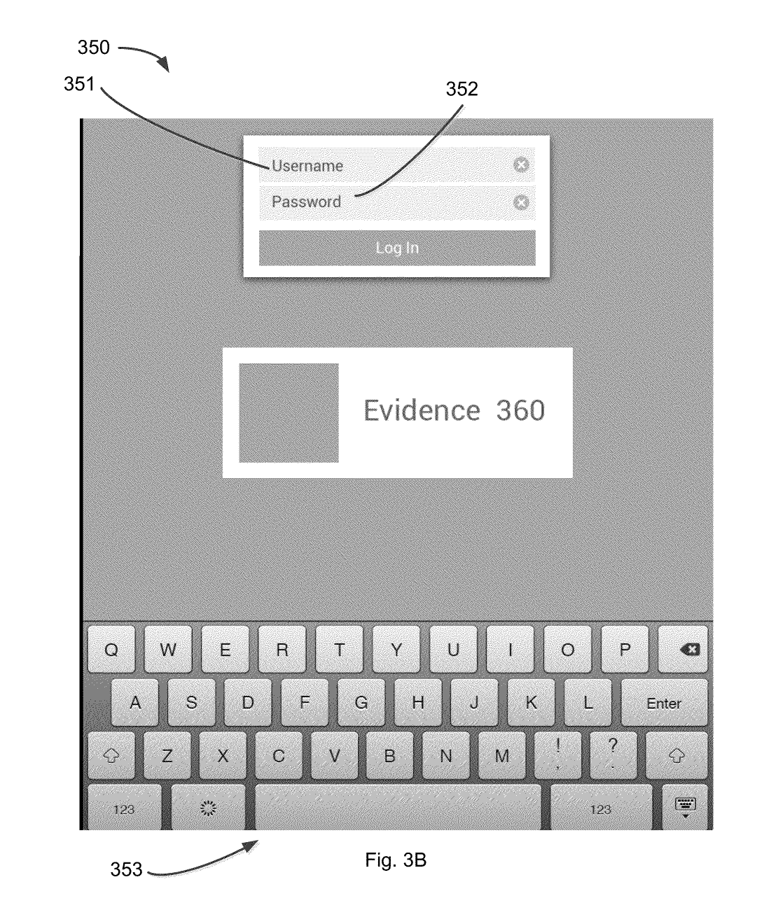

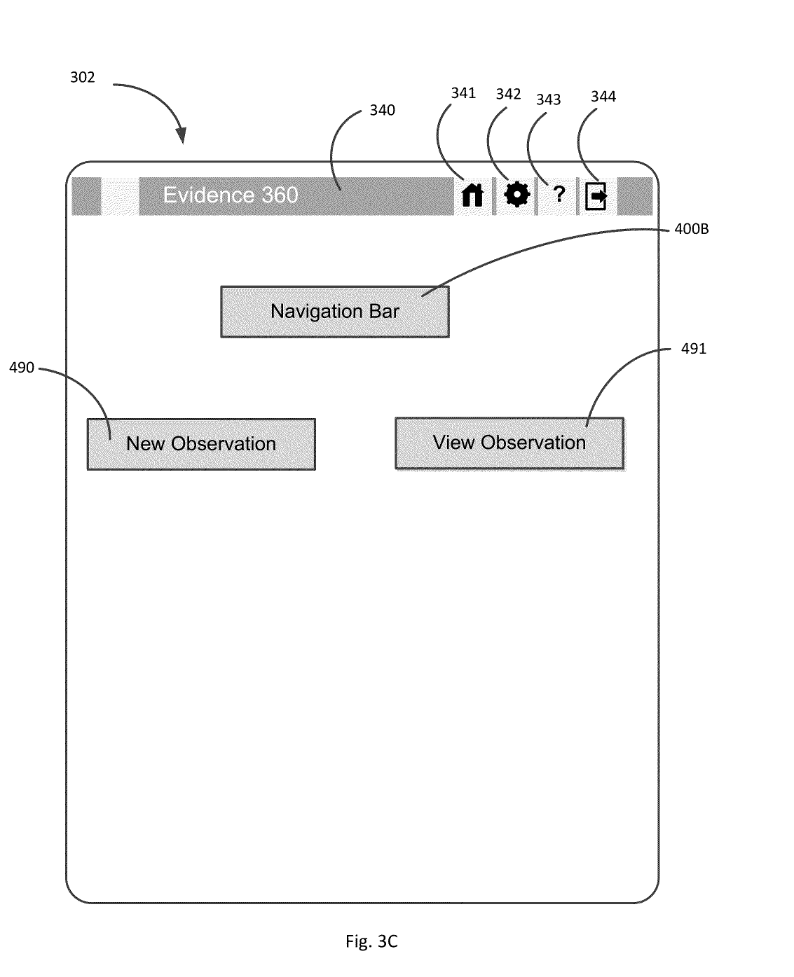

Referring to FIG. 3A, in illustrative embodiments, an observer begins his interaction with an observation environment (which may be referred to as “Evidence 360”) by logging-in to the system (e.g., the environment), as schematically illustrated by element 301 the flow chart 300.

An example of a log-in screen 350 shown on the screen (e.g. 102) of the observer's electronic data device e.g., 100 is schematically illustrated in FIG. 3B. In a process familiar to any computer user, the observer uses the keyboard 353 to enter a username 351 and password 352 to access the environment.

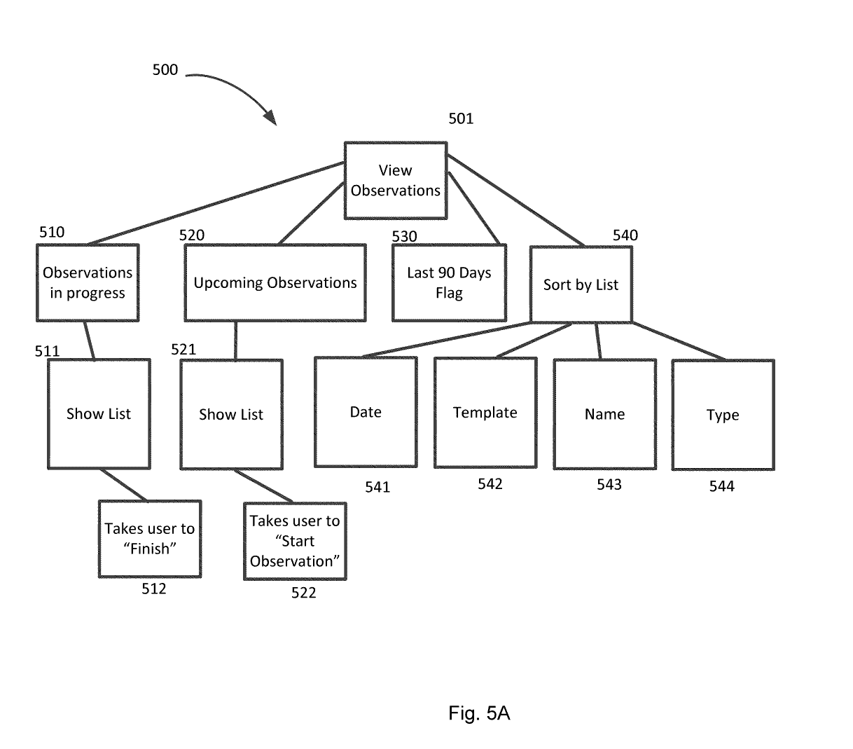

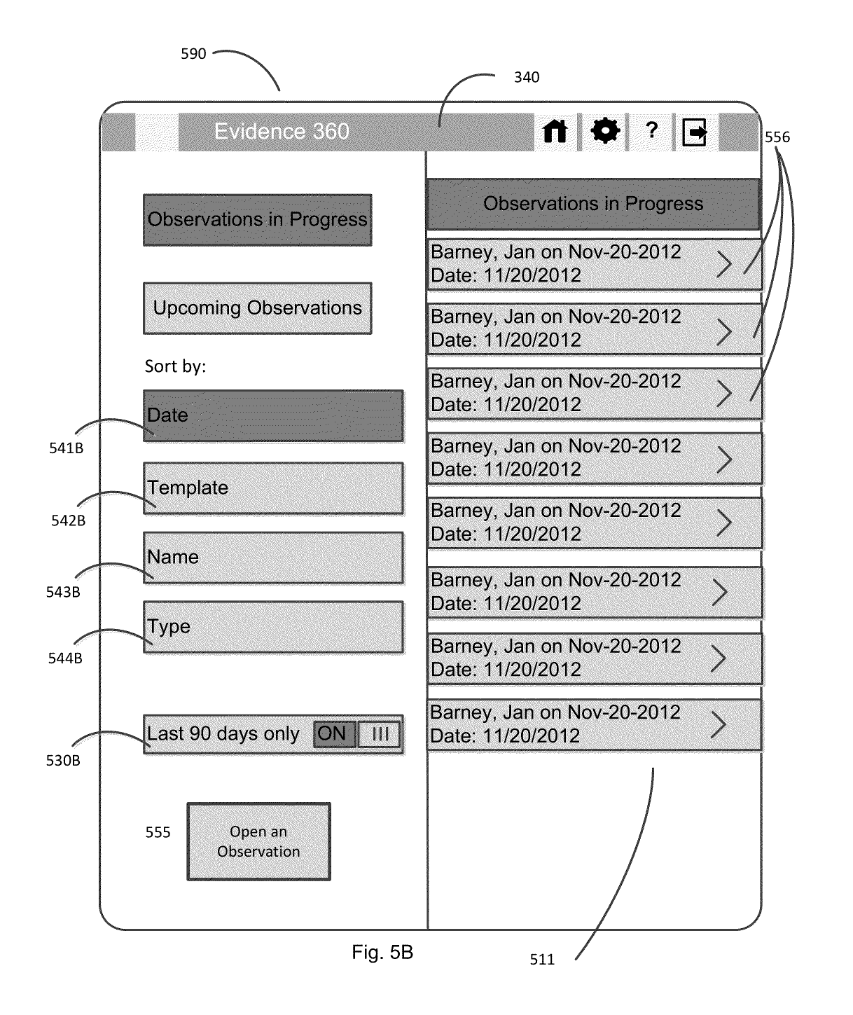

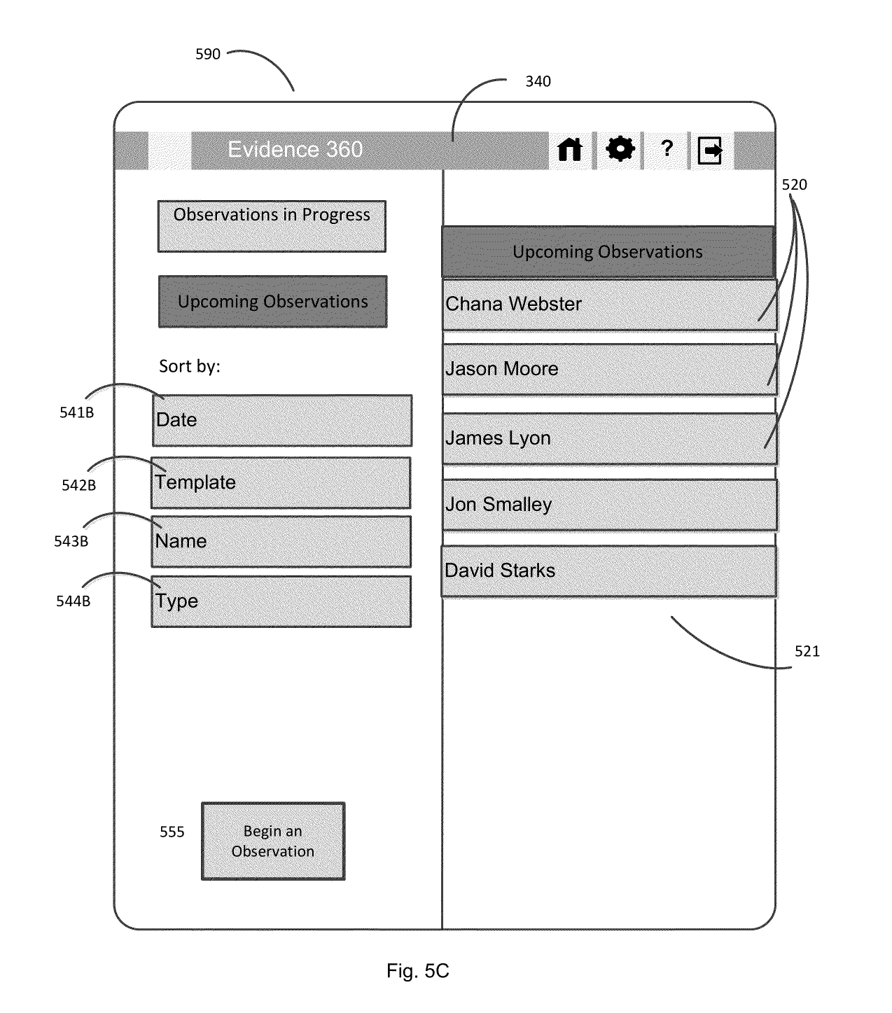

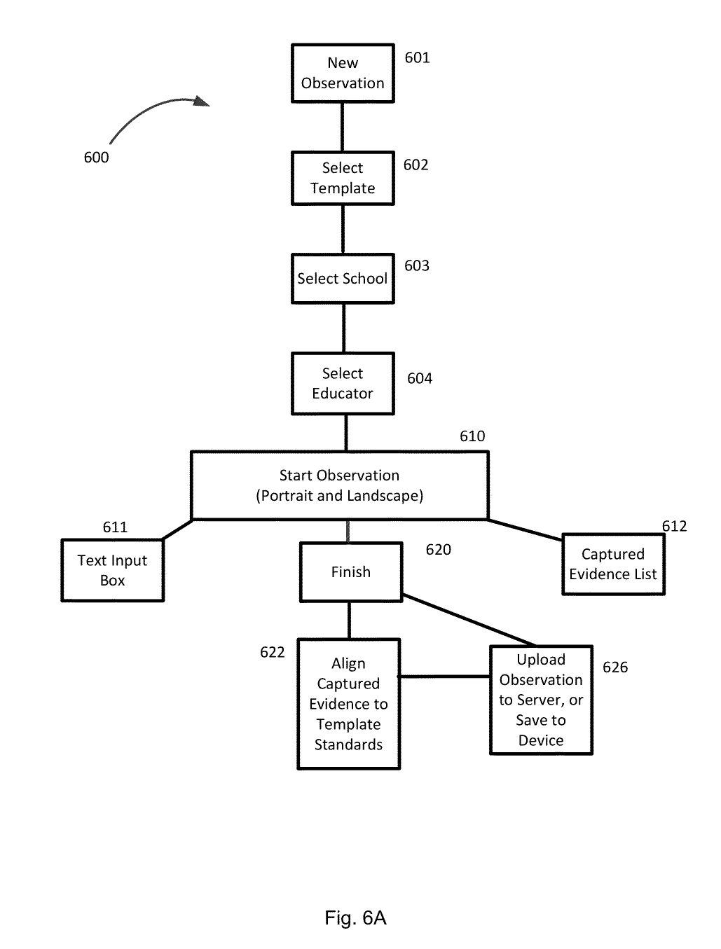

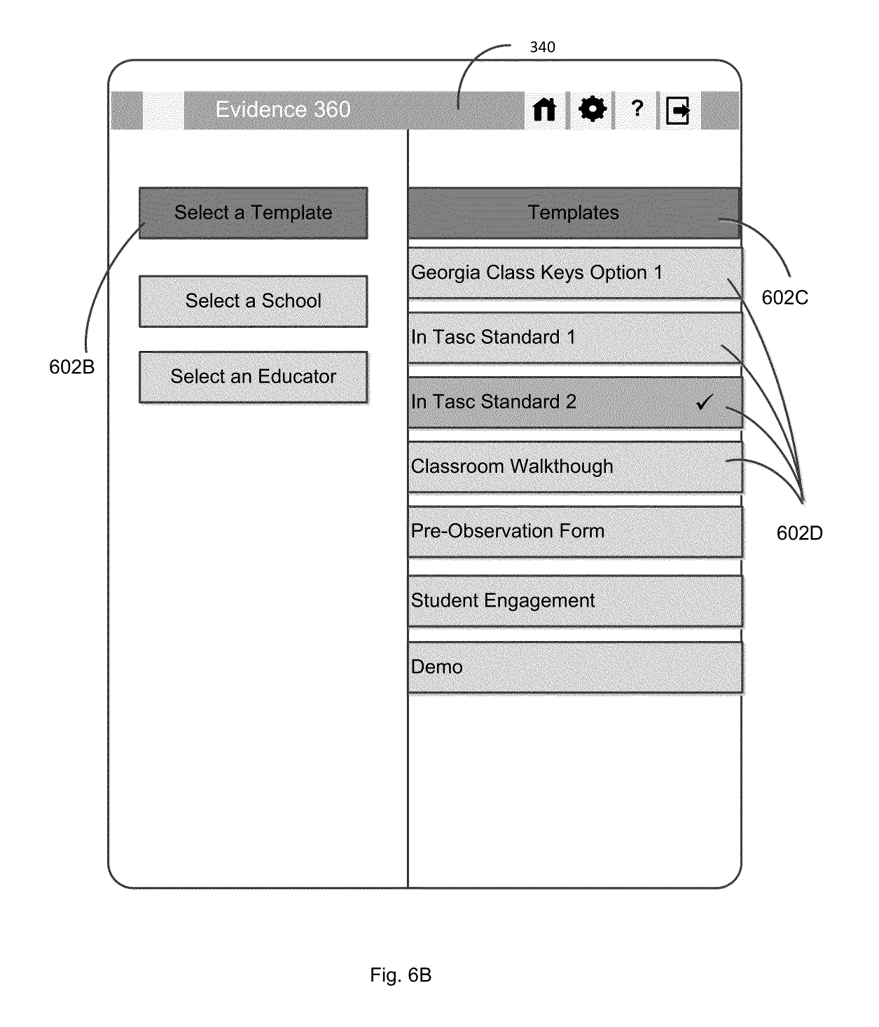

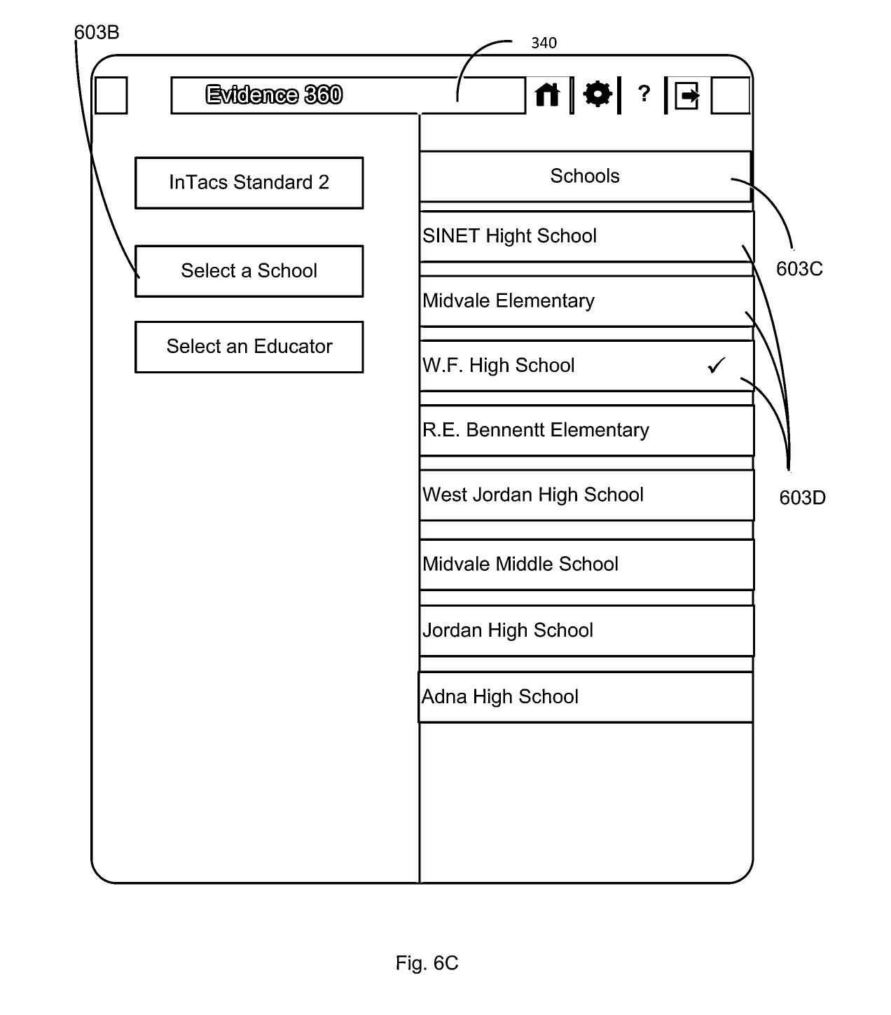

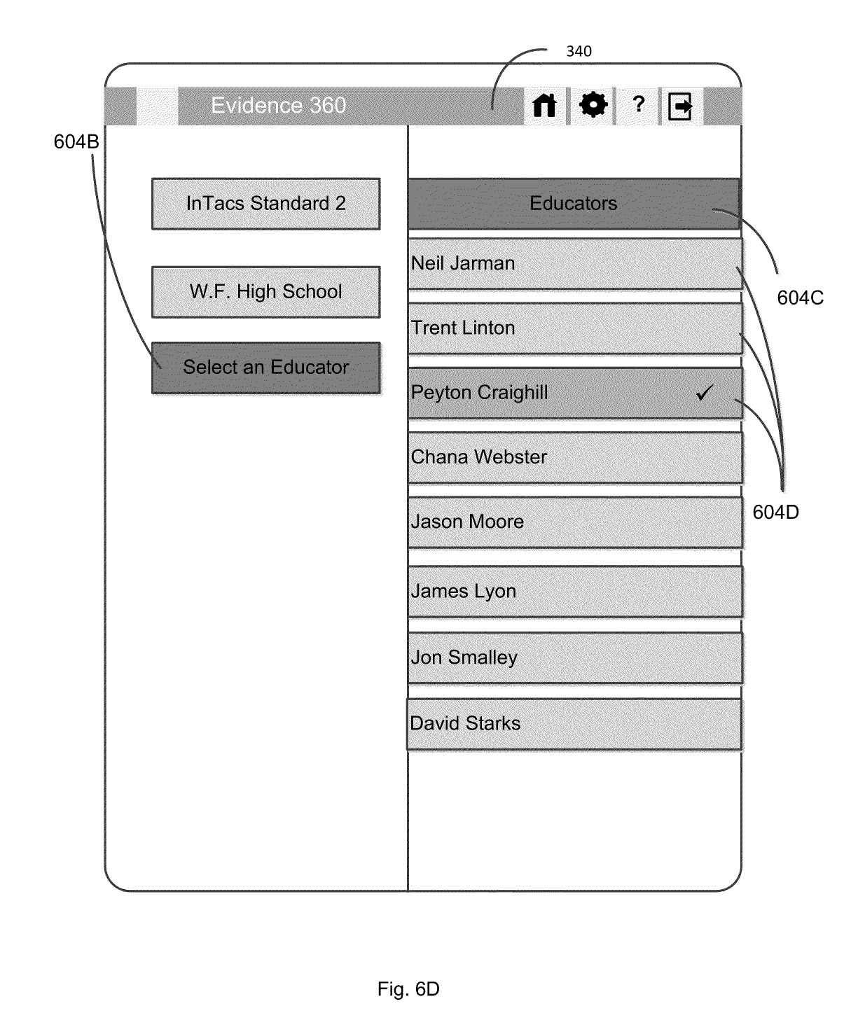

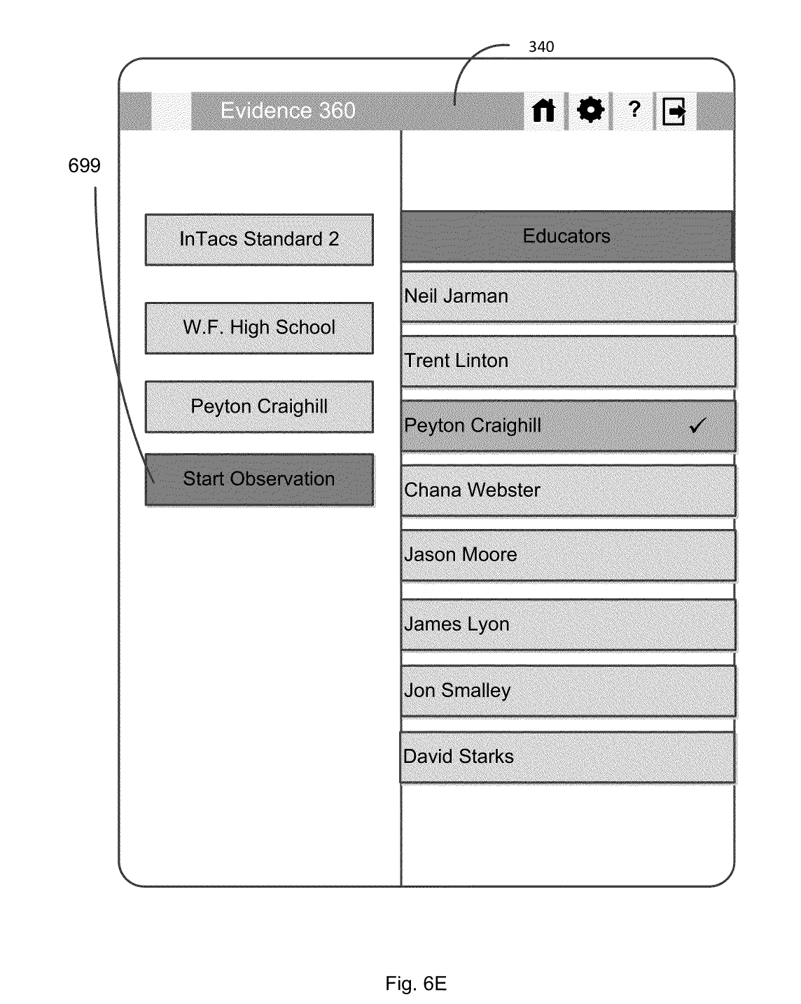

In some embodiments, the login process leads the observer to a home page 302 as shown in FIG. 3C, from which the observer may navigate to other portions of the environment, such as an interface (e.g., a page) to begin a new observation via control 490, an interface to view existing observations (e.g., observations for which at least some evidence has been recorded) via control 491, and/or a navigation interface to allow the observer to navigate to or access other features of the environment via control 400B. An illustrative process 500 for viewing observation is schematically illustrated in FIGS. 5A-5C, and an illustrative process 600 for beginning a new observation is schematically illustrated in FIGS. 6A-6E. The home page 302 contains, and other pages displayed to the observer may also contain, a navigation bar 340 to allow the observer to conveniently navigate within the system or to control the system. For example, the navigation bar 340 includes an icon 341 that, when activated from any page, causes the system to display, or returns the observer to, the home page 302. Similarly, activation of icon 342 takes the user to the “settings” interface 420 as described herein, activation of icon 343 takes the user to the “help” interface 430 as described herein, and activation of the “exit” icon 344 allows the user to finish or quit the observation, as described herein.

Navigation Bar

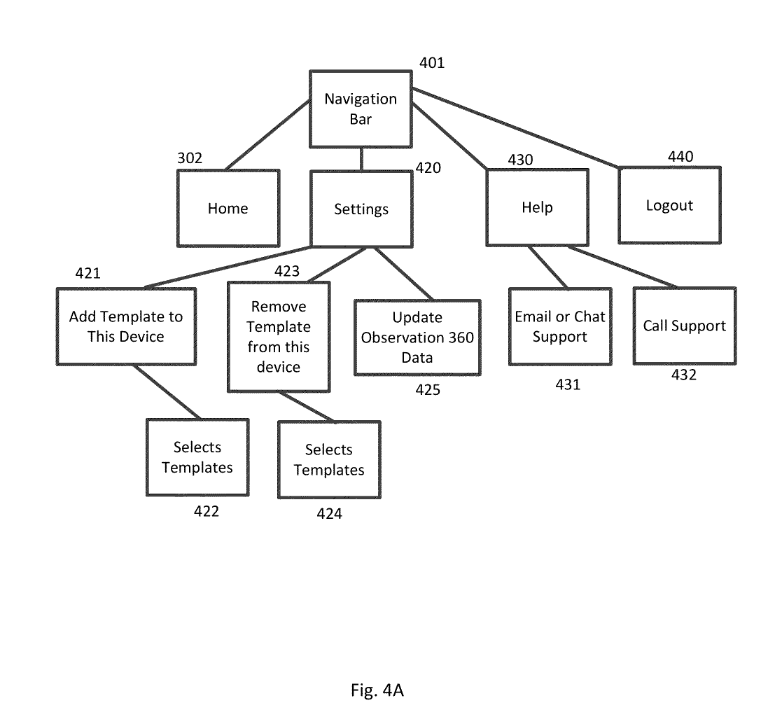

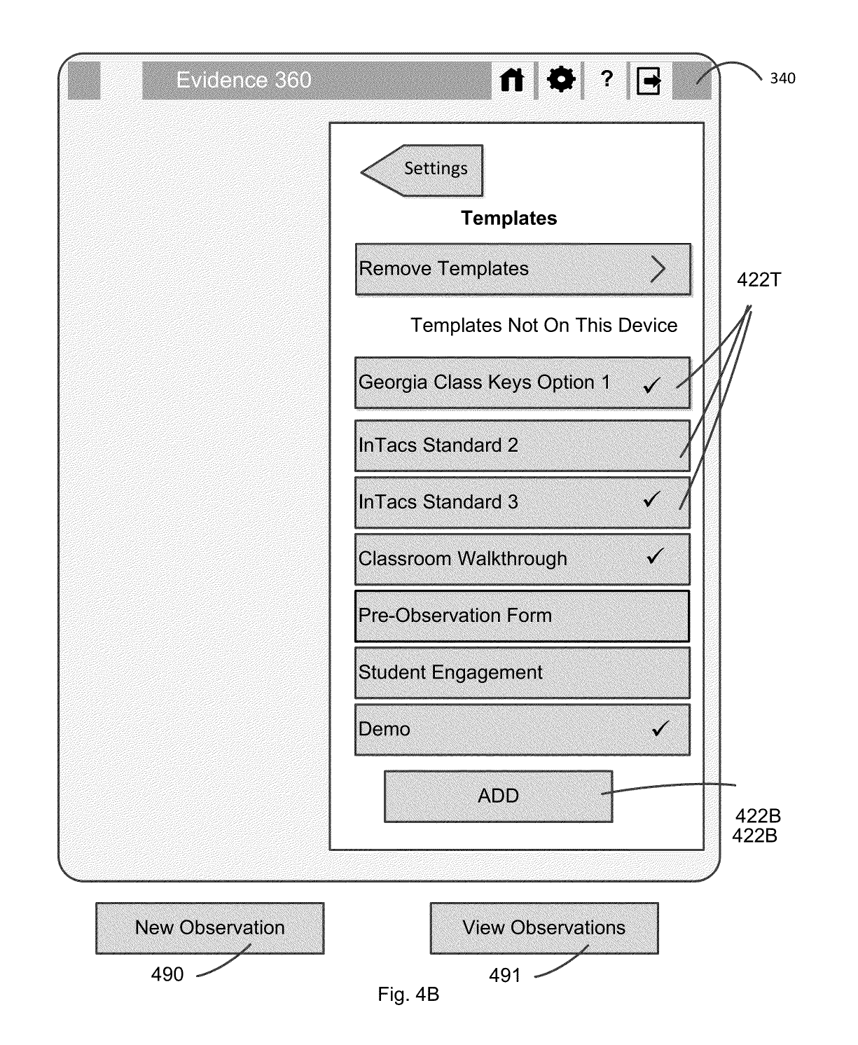

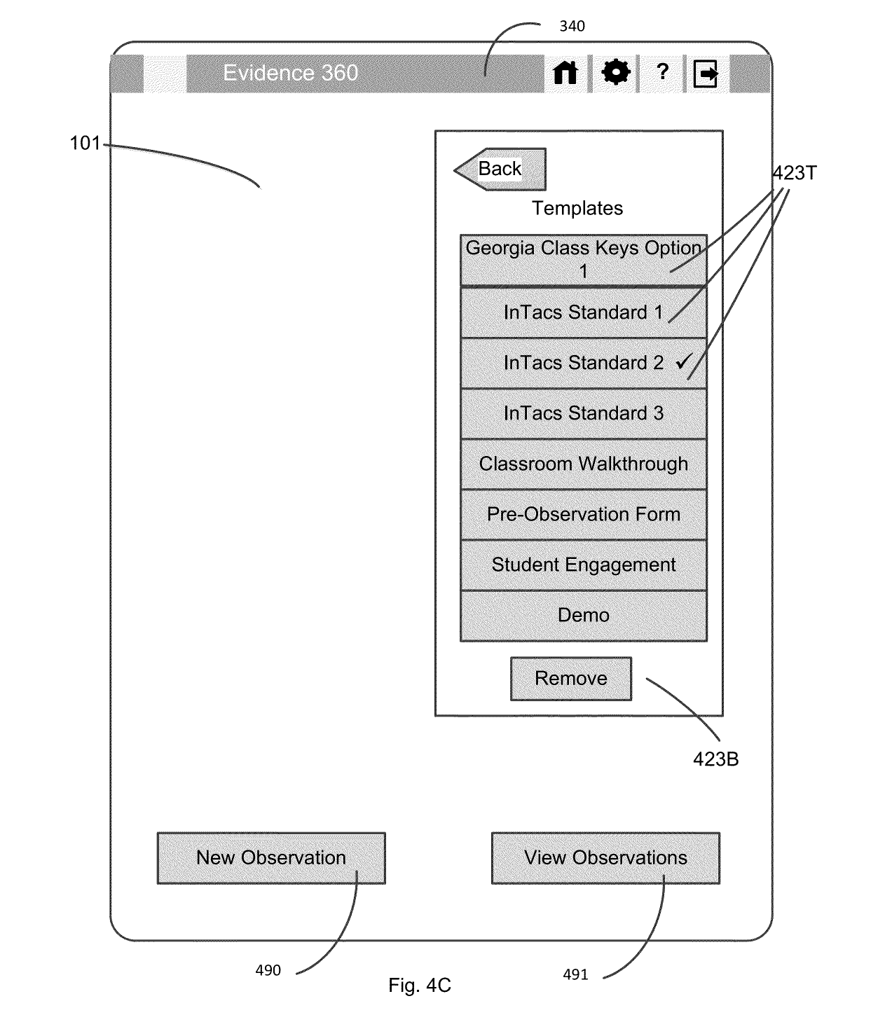

From the navigation interface (401, schematically illustrated in FIG. 4A), an observer may navigate, directly (e.g., by a single link or hop) or indirectly (e.g., by more than one hop) to a variety of other locations within the observation environment, including returning to the home page 302, or a logout page 440.

If an observer desires assistance, the navigation page 401 allows the observer to access directly (i.e., in one hop) a help interface 430. The help interface 430 may include information to inform the observer about how to contact a source of assistance, for example by providing a telephone number 432 to a support group, or by providing an email address or on-line chat facility 431 by which the observer may communicate with the support group.

Another interface reachable via the navigation interface 401 is a settings interface 420, through which the observer may manage the observation environment by, for example, selecting templates 422 to add to the environment 421, and/or by selecting templates 424 to remove 423 from the environment. An embodiment of a setting interface 420 as displayed on a data device 100 is schematically illustrated in FIG. 4B, in which a list of templates 422T not on the observer's device 100 is presented. The observer may select one or more templates (422T; each selected template is flagged by a check mark V), and may add the selected templates 422T to the data device 100 by activating the “ADD” button 422B.

An embodiment of another setting interface 420 as displayed on a data device 100 is schematically illustrated in FIG. 4B, in which a list of templates available on the observer's device 100 is presented. The observer may select 424 one or more templates (423T; shown in FIG. 4C; each selected template is flagged by a check mark ✓), and may remove or delete the selected templates 423T by activating the “REMOVE” button 423B.

From the settings interface 420, an observer may also update the observation system (e.g., update software that runs the system) or manage other aspects of the environment 425, or jump to the View Observations interface 501 (shown in FIG. 5A).

View Observation

From the View Observations interface 501, an observer may access a variety of features of the observation environment, as schematically illustrated in chart 500 in FIG. 5A. An illustrative embodiment of a View Observations interface page 590, as displayed on a screen 102 of a device 100, is schematically illustrated in FIG. 5B.

The View Observations interface 501 provides the observer the opportunity to view a listing or summary (e.g., 511) of observations in progress 556. An “observation in progress” is an observation for which at least some of the observations parameters (e.g., identification of the educator, identification of the school, selection of a template) have already been established. An “observation in progress” may also be an observation for which at least one item of observation evidence (e.g., 556) has been captured. The list or summary (e.g. 511) of such observations may also be limited to observations that have begun, or been accessed, within a defined time window. For example, a list or summary of observations may be limited to those observations that have begun or been accessed only within the last 90 days by setting a “Last 90 days only” switch (e.g., 530). Of course, the time period may optionally and controllably be set within the environment to an amount of time longer or shorter than 90 days, for example from the settings interface 420. An observer may also be provided an opportunity to open an observation in progress (e.g., by selecting button 555) to continue working on 512 that observation.

The View Observations interface 500 may also allow the observer to generate a list 521 of upcoming observations 522 via switch 520, as schematically illustrated in FIG. 5C. An “upcoming observation” is an observation for which observations parameters (e.g., identification of the educator, identification of the school, selection of a template) have not yet been established. For example, an educator might be identified as due for an observation, and that information may be listed as an “upcoming observation,” even though no observation records have been created or begun in the observation environment. An observer may also be provided an opportunity to open a new observation (e.g., by selecting button 555) to begin creating observation records 522 for a new observation.

The View Observations interface 500 may also allow an observer to sort a list or summary (e.g., 511, 521) by date 541, template used in an observation 542, name of educator 543, or observation type 544, for example by activating controls 541B, 542B, 543B and 544B, respectively. Observations may be classified by type, such a first observation of a given teacher; second observation of a given teacher; mid-year observation, or end-of-year observation, observation of a novice educator; observation of an experienced educator; or observation of a senior educator; to name but a few examples.

New Observations; Capturing Data

In illustrative embodiments, the process of capturing evidence for an observation begins, or continues, from the Observation interface, as schematically illustrated by the flow chart 600 in FIG. 6A). From the Observation interface 600, an observer may begin a new observation 601, or continue with a previous observation (e.g., 610). It should be noted that any of the interfaces or pages described herein may include one or both of a control to allow the user to begin a new observation by activating the control (e.g., control 490) or to view a list of existing observations (e.g., control 491).

To begin a new observation, the observer selects a template (step 602), for example selecting or activating a “Select a Template” button 602B, shown in FIG. 6B, which causes a list 602C of available templates 602D to be displayed on device 100. The observer may make a selection by selecting (e.g., clicking on) a template 602D, which may also cause the selected template to be identified on button 602B. An example of a page, or interface, shown in the screen 102 of a data device 100, for selecting a template is schematically illustrated in FIG. 6B. In addition, the step 602 of selecting a template may include creating a template and/or modifying a pre-existing template. A selected template may be indicated by a check mark (✓) next to the name of the selected template. The identity of the selected template is a parameter of the observation, and is included in the record of the observation.

At step 603, the observer may select the school at which the observer will observe an educator. An example of a page, or interface, shown in the screen 102 of a data device 100, for selecting a school is schematically illustrated in FIG. 6C. Selecting or activating a “Select a School” button 603B, shown in FIG. 6B, causes a list 603C of available schools 603D to be displayed. The observer may make a selection by selecting (e.g., clicking on) a school 60D, which may also cause the selected school to be identified on button 603B. A selected school may also be indicated by a check mark (✓) next to the name of the selected school. The identity of the selected school may be a parameter of the observation, and is included in the record of the observation. Alternately, if the school is already known (e.g., because the system is dedicated to use in a defined school), the step of selecting a school may be skipped.

The observer may also specify the educator who is the subject of the observation, at step 604. An example of a page, or interface, shown in the screen 102 of a data device 100, for selecting an educator is schematically illustrated in FIG. 6D. Selecting or activating a “Select an Educator” button 604B, shown in FIG. 6D, causes a list 604C of available educators 604D to be displayed. The observer may make a selection by selecting (e.g., clicking on) an educator 604D, which may also cause the name of the selected educator to be identified on button 604B. A selected educator may also be indicated by a check mark (✓) next to the name of the selected educator. The identity of the selected educator may be a parameter of the observation, and is included in the record of the observation.

In addition, it should be noted that in various embodiments, the steps 602, 603 and 604 may be performed in an order different than the order shown in FIG. 6A (e.g., 602-603-604; 602-604; 603-604-602, etc.), and one or more may be skipped, for example if the item to be selected has been pre-selected or previously specified.

Once the fundamental parameters of an observation have been established (e.g., standard selected, school identified, educator specified), the system may present the observer a button (699; FIG. 6E) that allows the observer to start collecting evidence for the observation.

In general, the data that populates the various lists discussed herein (e.g., templates available for downloading to the device 100 or to an educational environment; templates available to be selected for an observation; lists of schools available to be selected for an observation; educators available to be selected for an observation) are provided to a data device 100 by being served to the device 100 over a network (e.g., 202, as shown in FIG. 2) from a server (e.g., 201, as shown in FIG. 2). Later, as discussed more fully below, the data device 100 will send data to the server, such that the server (e.g., 201) receives, over the network (e.g., 202) observation data created by the observer. The server (e.g., 201) may then store the data received from the data device 100.

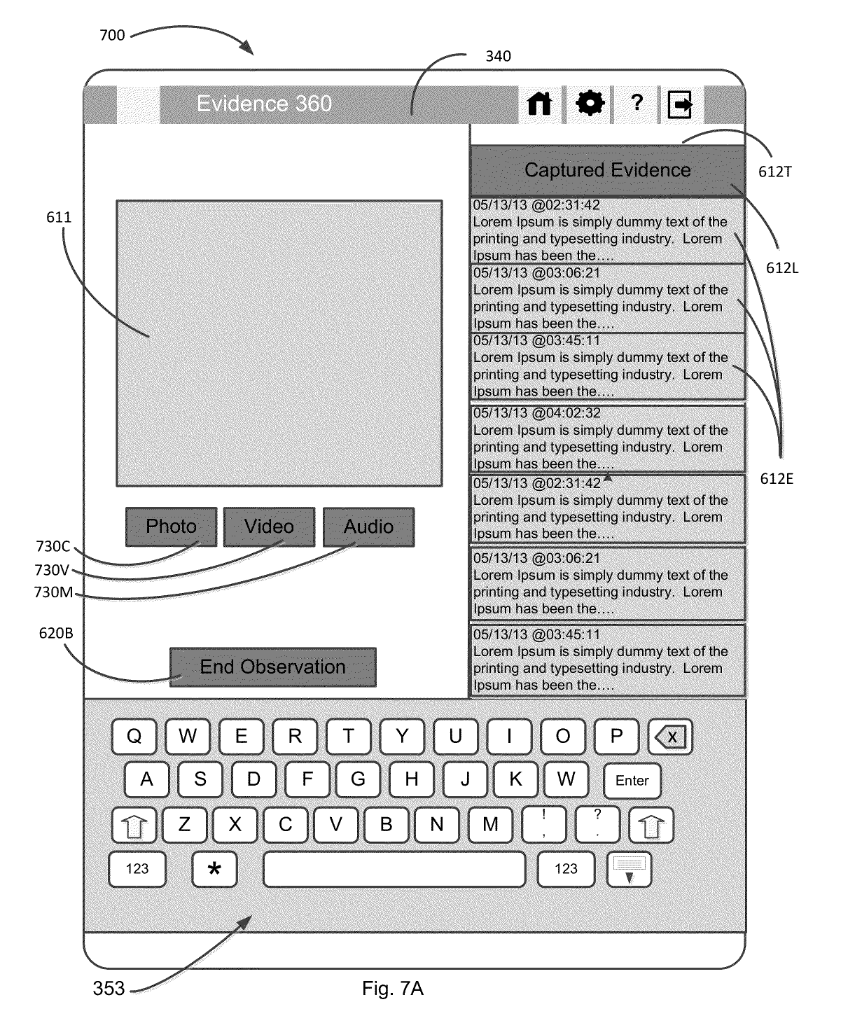

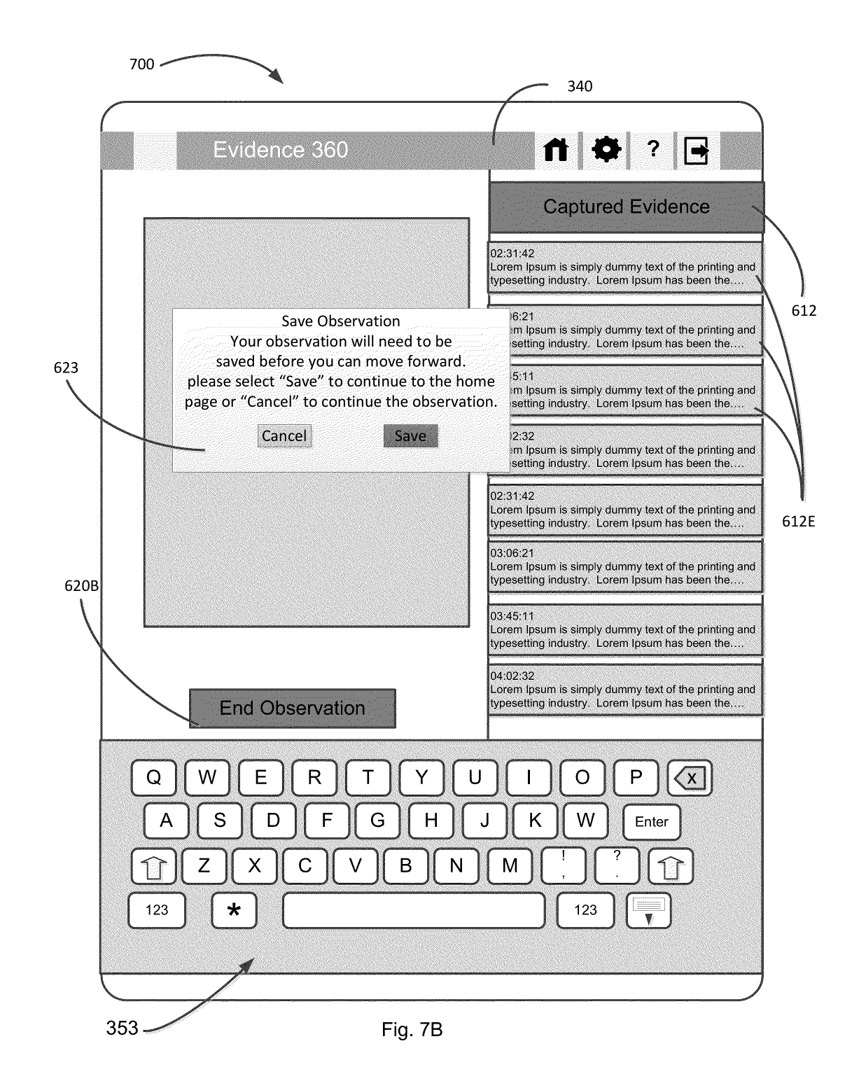

When the observer is ready to capture evidence of in an observation, the observer may begin the observation (step 610, shown in FIG. 6A). The environment facilitates the capture and recording of observation evidence by providing an evidence capture interface 700, as schematically shown for an illustrative embodiment in FIG. 7A and FIG. 7B.

The evidence capture interface 700 may provide a variety of features for collecting evidence, such as a text input box 611 in which the observer may, using virtual keyboard 353, type observations (e.g., each a paragraph) of the educator's actions. Each paragraph may be time-and-date stamped with time and date information 612T for purposes of indexing and organizing the observations. A list 612L of the captured evidence (e.g., paragraphs 612E) may be displayed on the screen 102 adjacent to the text input box 611, for example to provide an ongoing context for reference by the observer.

The evidence capture interface 700 may also provide one or more of controls 730C, 730V, 730M for recording still photographs, audio recordings, and/or video clips respectively, of the educator in action, for example using still-camera 110, a microphone 112, and/or a video camera 111. As with paragraphs, each photograph, video clip and audio recording may be time-and-date stamped for purposes of indexing and organizing the observations. Paragraphs, still photographs, audio recordings, and/or video clips may be capturing contemporaneously with one another, and may optionally be included in the evidence listing 612.

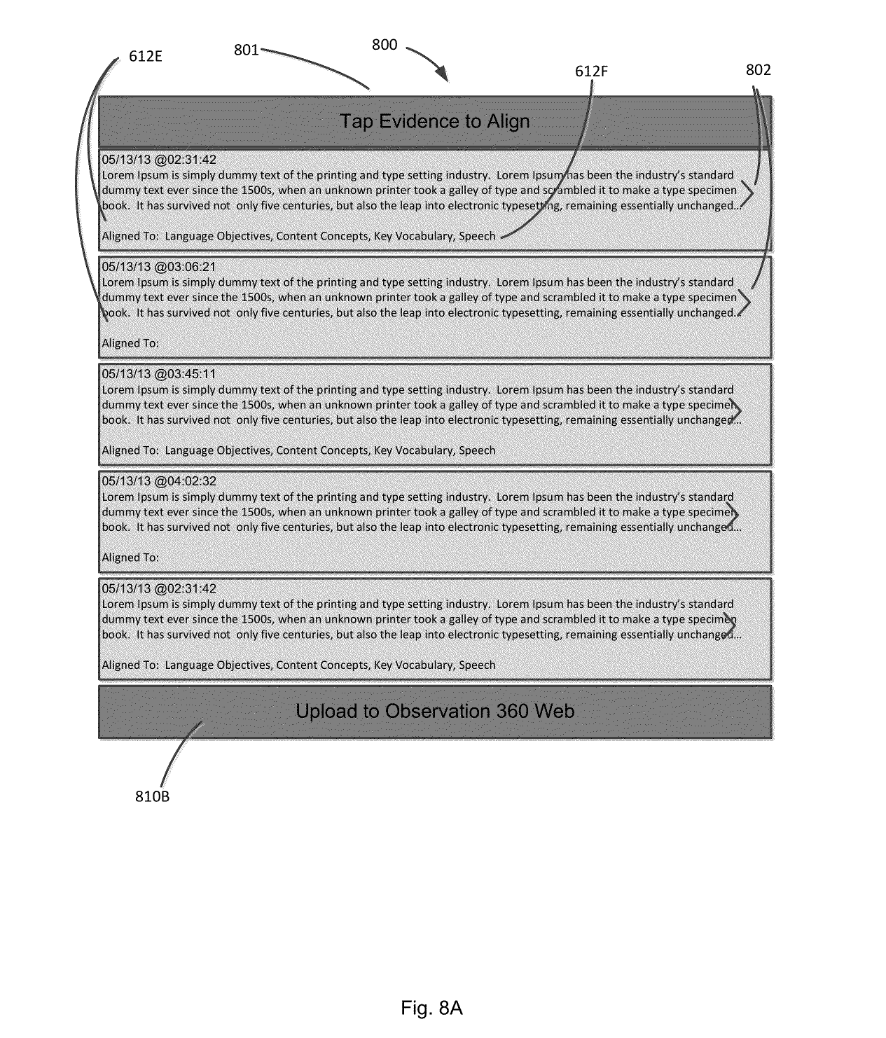

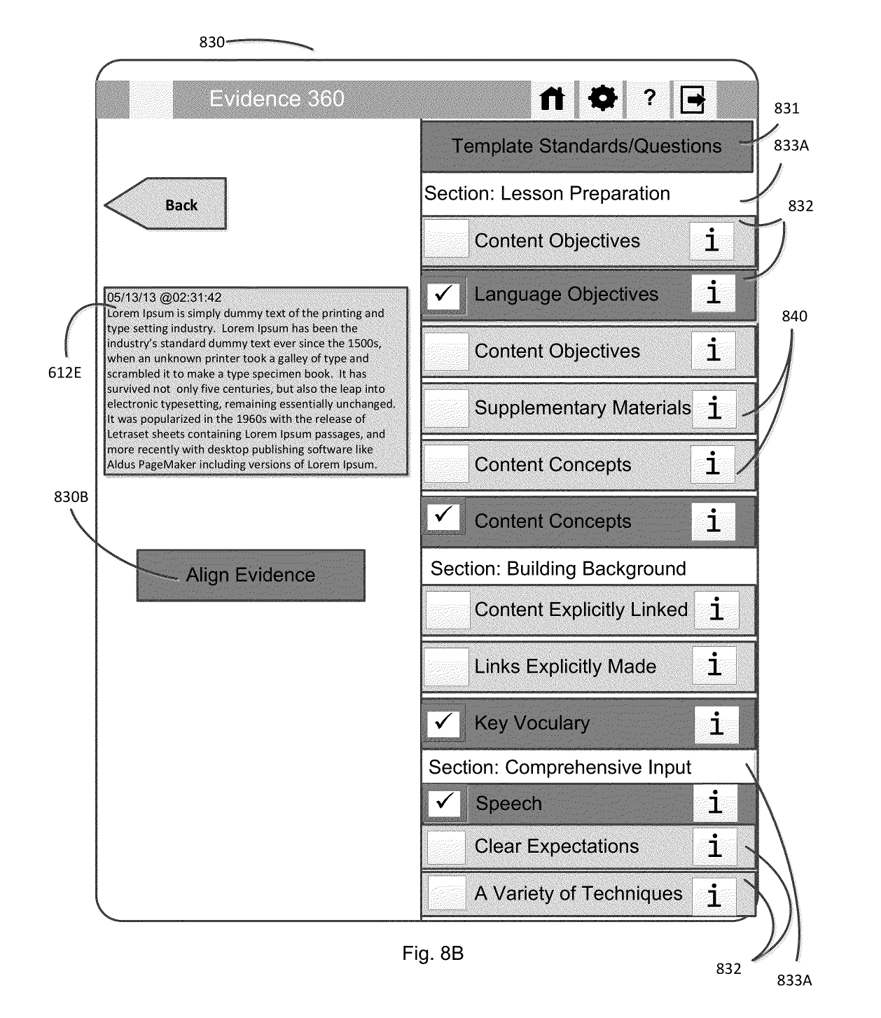

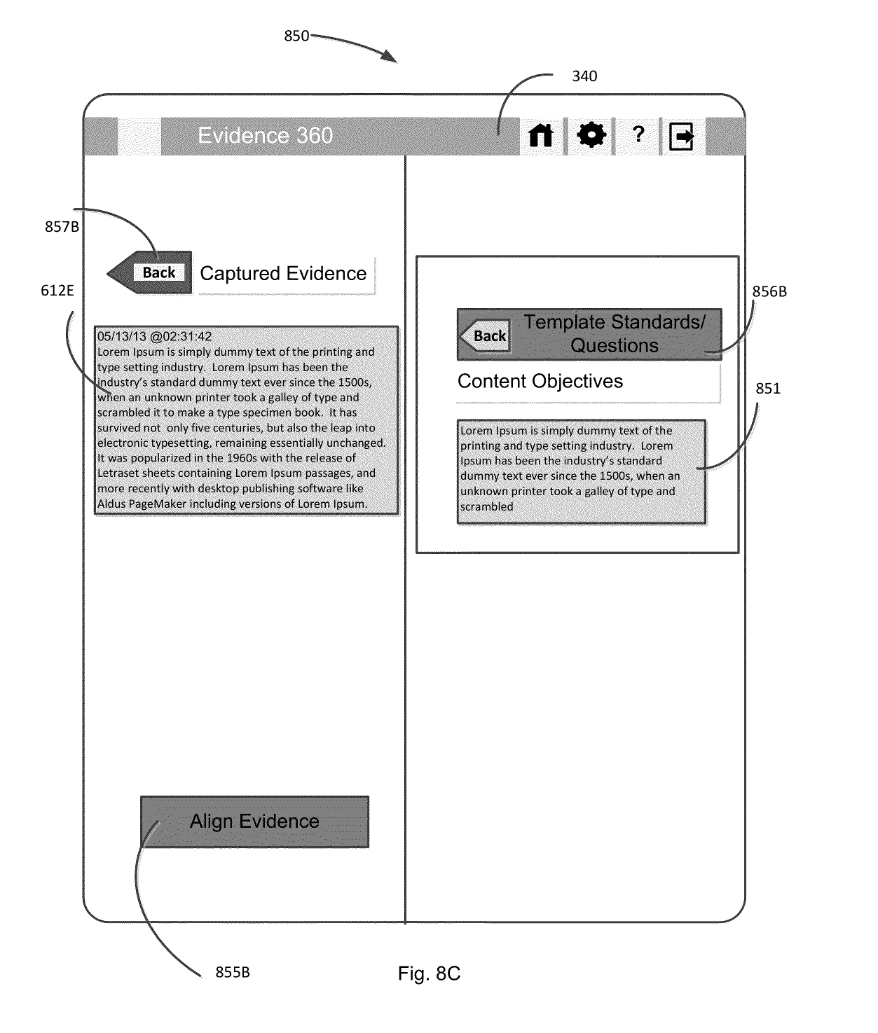

An observer may pause or end an observation or observation session 620 by, for example, activating an “End Observation” control 620B. Upon activating the “End Observation” control 620B, the environment may provide to the observer a control 623 to allow the observer to save the captured evidence and other data in the observation record, or alternately to cancel the observation session, in which case the captured evidence and other data is not saved. In saving the captured evidence and other data, the environment may send the captured evidence and other data to a server (e.g., 201) across a network (e.g., 202). After pausing or ending the observation, the system presents to the observer the opportunity to align the captured evidence 622 to the template standards from the previously-selected template as described below, and to upload 626 the captured evidence, by itself or along with data recording the alignment (e.g., “alignment data”) from the observer's device 100 to the server 201 for later use, for example in generating an evaluation report as described herein, or to save the captured evidence and/or alignment data to the observer's device 100. Aligning captured evidence to template standards is further described in connection with FIGS. 8A-8C herein, and saving the captured evidence is further described in connection with FIG. 7B herein and in connecting with FIG. 8A herein.

Aligning Evidence

After capturing evidence, the observer may correlate, or “align” the captured evidence to the template standards within the selected template. Such aligning may be done immediately after the evidence is captured, or may be done at a later time (e.g., using stored evidence).

The environment facilitates the aligning the data to template standards by providing an evidence alignment interface 800, as schematically illustrated for an illustrative embodiment in FIG. 8A, FIG. 8B, and FIG. 8C.

In an illustrative embodiment shown in FIG. 8A, the environment displays, on screen 102 (not shown), a listing 801 of some or all of the set of captured evidence 612E (e.g., paragraphs, photographs, video clips, audio recordings), each having an associated control (e.g., arrowhead 802) that allows the observer to initiate alignment of the associated item of captured evidence 612E with one or more template standards shown in FIG. 8B. Note that a given item of captured evidence 612E may, at any given time, be aligned with (e.g., correlated to) one or more template standard. Similarly, a given template standard may, at any given time, be aligned with (e.g., correlated to) one or more items of captured evidence. Once an item of captured evidence 612E is aligned to a template standard, the displayed item of captured evidence 612E may include text or other symbol 612F identifying the template standard or standards to which that item of captured evidence is aligned.

When an observer activates an alignment control 802, the environment displays and alignment interface 830 (FIG. 8B). In the illustrative embodiment schematically illustrated in FIG. 8B, the alignment interface 830 includes a display of the associated item of captured evidence 612E, as well as a listing 831 of the template standards 832 for the template associated with the observation. The template standards 832 may be grouped by sections (e.g., 833A, 833B), wherein a template standard 832 grouped into each section 833 is deemed to have a common theme with other template standards 832 in that group 833. For example, template standards 832 directed to lesson preparation may be gathered in a first group (e.g., 833A), and template standards 832 directed to comprehensive input may be gathered in a second group (e.g., 833B).

In some embodiments, the alignment interface 830 may provide to an observer a feature by which the observer may be reminded of the description of a given template standard 832. Such information may assist the observer in understanding the template standards 832 and therefore to better align the available items of captured evidence 612E to the available template standards 832. To that end the environment may provide a descriptor control 840 associated with educational template standard, as schematically illustrated in FIG. 8B. When an observer activates a descriptor control 840, the environment causes the screen 102 to display a template standard definition interface (850; FIG. 8C), which includes a display of an available item of captured evidence 612E along with a description of the scope (e.g., content objectives) of that template standard 832.

As such, the observer may more readily determine whether the displayed item of captured evidence 612E should be aligned with the selected template standard 832. If the observer determines that the displayed item of captured evidence 612E should be aligned with the selected template standard 832, the observer may commit the alignment by activating an “Align Evidence” control (e.g., 855B). Otherwise, the observer may return to the alignment interface 830 by activating a “Back” control (e.g., 856B). Alternately, the observer may navigate to the captured evidence list 801 by activating another “Back” control (e.g., 857B).

When the observer has completed some or all of the alignment process, the observer may save the observation record by, for example, submitting or saving the observation record to a server (e.g., 201) via a network (e.g., 202). To that end, the environment serves to the data device 100 a control 810B that, when activated by the observer, causes some or all of an observation record to be transmitted to such a server (e.g., 201).

Creating an Evaluation Report

After the reporter has gathered the captured evidence, he may use some or all of that captured evidence to begin a new evaluation report, or supplement a pre-existing evaluation report, that evaluates the observed teacher. In some embodiments, the observer may generate an evaluation report by assessing the teacher against the template standards of a rubric.

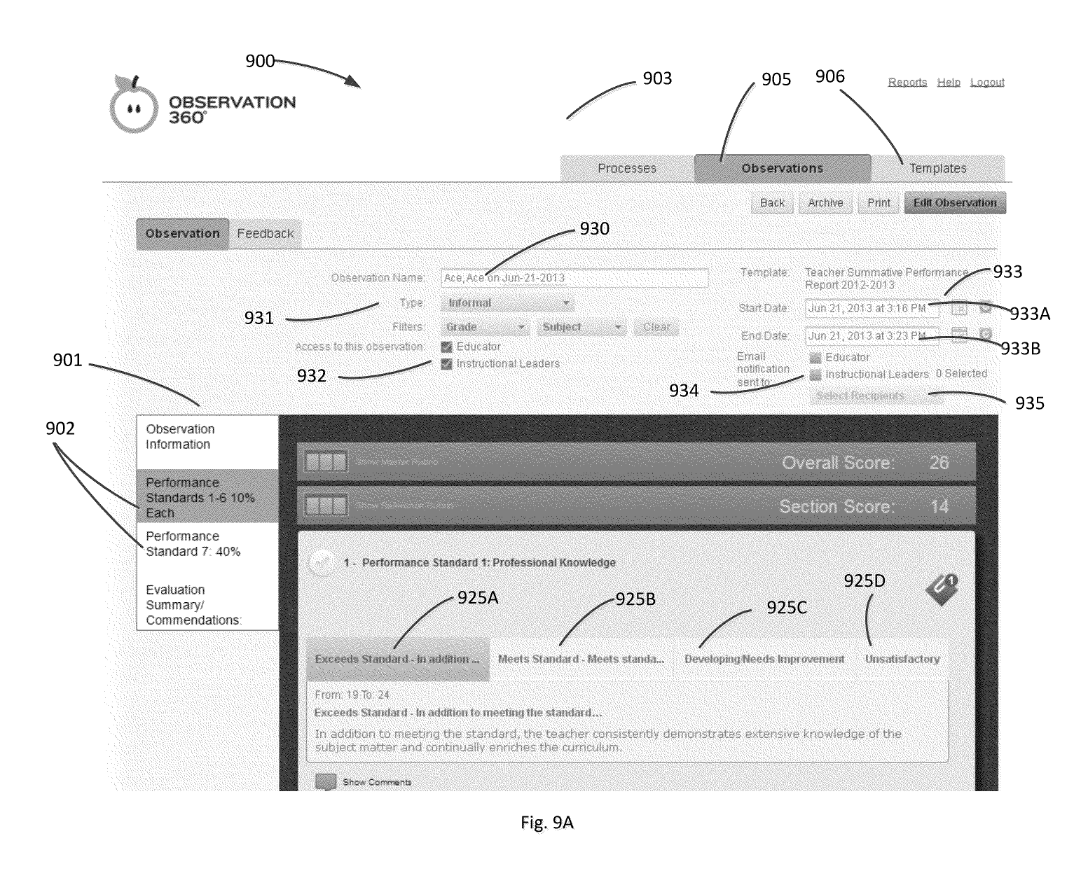

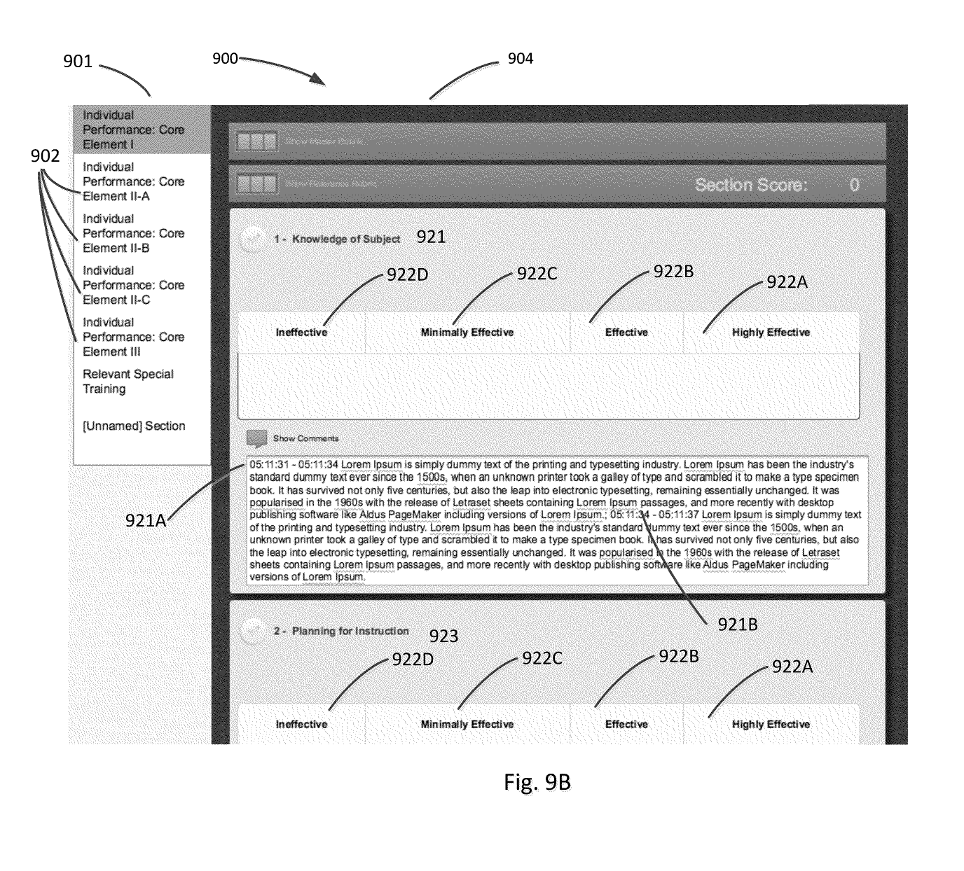

An embodiment of an evaluation interface 900 is schematically illustrated in FIG. 9A. This embodiment includes a menu 901 of template standards or groups 902 of template standards, and allows an observer to select a group of template standards to address, or to select a desired template standard.

The evaluation interface 900 may display to the observer information relating to the template standards and the use of the template standards. For example, the evaluation interface 900 displays a template standard 921 (in FIG. 9B, the template standard is “Knowledge of Subject”; another template standard 923 is “Planning for Instruction”), along with elements of captured evidence (921A, 921B) that have been aligned to that template standard, as well as four rating options 922A, 922B, 922C and 922D, each of which allows the observer to assign a rating to the teacher's compliance with that template standard. As another example, the evaluation interface 900 displays a template standard 923 (“Performance Standard 1: Professional Knowledge”) as schematically illustrated in FIG. 9A, and also displays tabs 925A, 925B, 925C and 925 corresponding to four rating standards available to be associated with that template standard 923. The tabs 925A, 925B, 925C and 925D in FIG. 9A may also display a definition or description of rating criteria for determining whether a teacher's observed performance meets the rating option.

In each of the foregoing examples, the rating options 925A, 925B, 925C and 925D, and 922A, 922B, 922C and 922D, present to the observer a range of options on a scale from a top rating (e.g., 925A “Exceeds Standard” or 922A “Highly Effective”) to a bottom rating (e.g, 925D “Unsatisfactory” or 922D “Ineffective”), with other scale points inbetween. As such, the observer has a variety of options for evaluating the teacher's performance for each template standard, and also has access to a description of what is required to meet each available rating option.

In determining which rating to assign, the observer may review the associated captured evidence (922A, 922B, etc.), and compare that captured evidence against the various rating criteria to determine which of the ratings best describes the teacher's performance.

When the observer selects a rating option, the system records that selection, so that the selected rating option is correlated to the template standard. As such, the evaluation report includes among its data at least the template standards and the rating selected for each template standard, and may also include the associate captured evidence.

The observer may save the evaluation report when it is complete (i.e., when the observer has completed assigning ratings to each template standard, or to a subset of the template standards, or at any intermediate point, before the evaluation report is complete. If the observer saves the evaluation report at an intermediate point, then that evaluation report is a report in progress, and may be retrieved by the observer at a later point in time for additional input.

To facilitate generation of an evaluation report, the evaluation interface 900 may include a number of control features. For example, the evaluation interface 900 includes an input box 930 configured to receive text identifying the observer, a drop-down menu 931 to allow the observer to select an evaluation type, one or more check boxes 932 configured to allow the observer to limit or grant access to the evaluation report by third parties, one or more input boxes 933 configured to receive date data identifying the start date 933A and end date 933B of the observation, and one or more check boxes 934 and drop-down menus 935 configured to allow the observer to notify, such as by email, third parties as to the status of the evaluation report.

The evaluation interface 900 may also include navigation controls, such as a tab 905 which causes the evaluation interface 900 to display the observation interface page 903 as schematically illustrated in FIG. 9A, and a templates tab 906, which causes the evaluation interface 900 to display the ratings page 904 as schematically illustrated in FIG. 9B.

Illustrative System Architecture

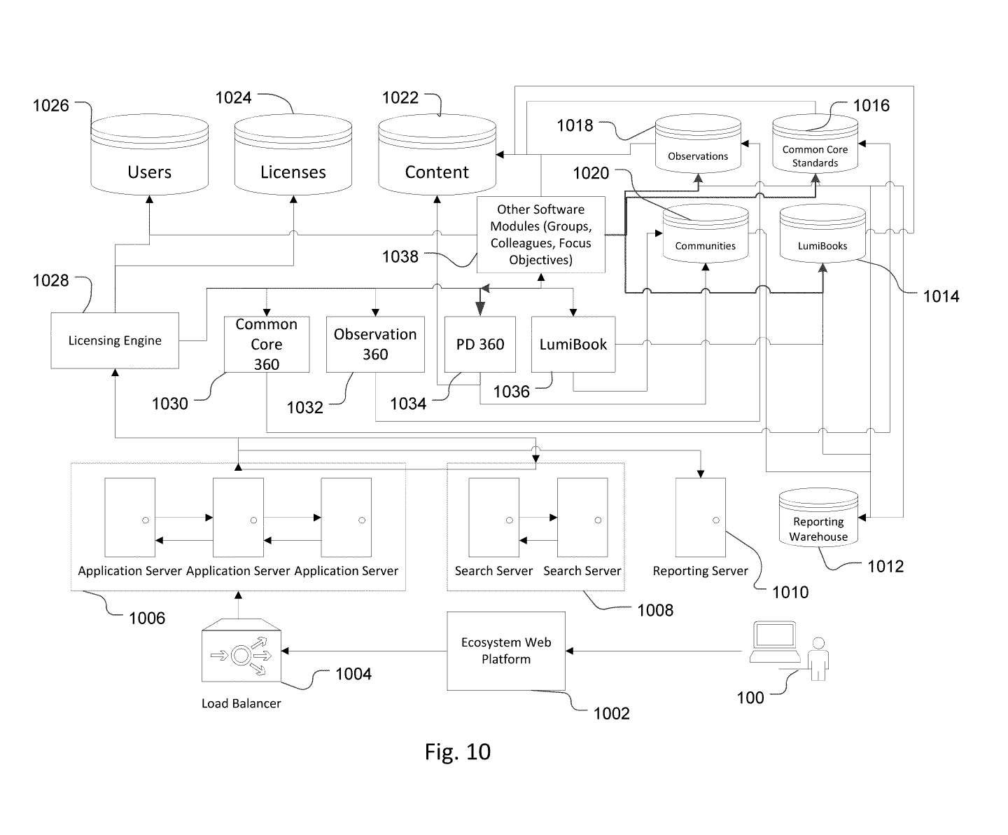

FIG. 10 is a diagram showing an example of a system architecture for a computer-implemented educational environment of the general type used by various embodiments. Client computers 100 access the educational ecosystem web platform 1002 over the internet or other wide area network. The load placed on the system by the client computers 100 is balanced by load balancer 1004, which is coupled to a server system implemented by a series of application servers 1006 in a peer-to-peer configuration. Part of the server load is offloaded to a series of search servers 1008 and a reporting server 1010 for report generation, which in turn accesses reporting data warehouse 1012. These servers are coupled to licensing engine 1028, which determines resources that are available to any specific user accessing the platform from a client computer. The licensing engine accesses the license database 1024 and the user database 1026 to determine eligibility and makes available licensed resources to the client computers 100 of the users. These may include various applications, such as Common Core 360 (item 1030), Observation 360 (item 1032) for which observation data is stored in observation database 1018, PD360 (item 1034) and its associated content via database 1022, and LumiBook (item 1036). Additional databases store common core standards 1016, forum and related data relating to communities 1020, and LumiBooks 1014.

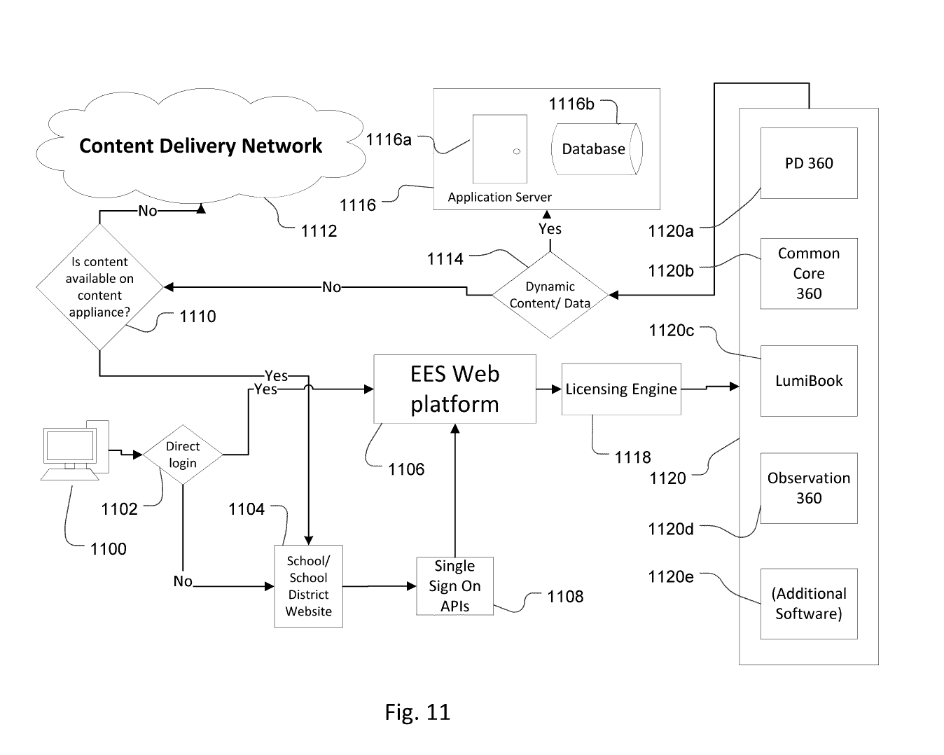

FIG. 11 is a block diagram showing logical flow associated with providing educational resources using the system architecture of FIG. 10. The client computer 1100 encounters the login screen in process 1102, and if there is a successful login, process flow moves to the educational ecosystem platform at 1106, otherwise the school or school district website is presented in process 1104. From that website there is enabled a single sign-on application programming interface that provides another path 1108 to the ecosystem platform 1108. At that point the licensing engine 1118 determines access to resources such as the applications PD360 (1120a), Common Core 360 (1120b), LumiBook (1120c) and Observation 360 (1120d). The applications in turn access dynamic content and data via application server 1116 and database 1116b. Other content may be accessed from content delivery network 1112 if it is not available locally the school or school district.

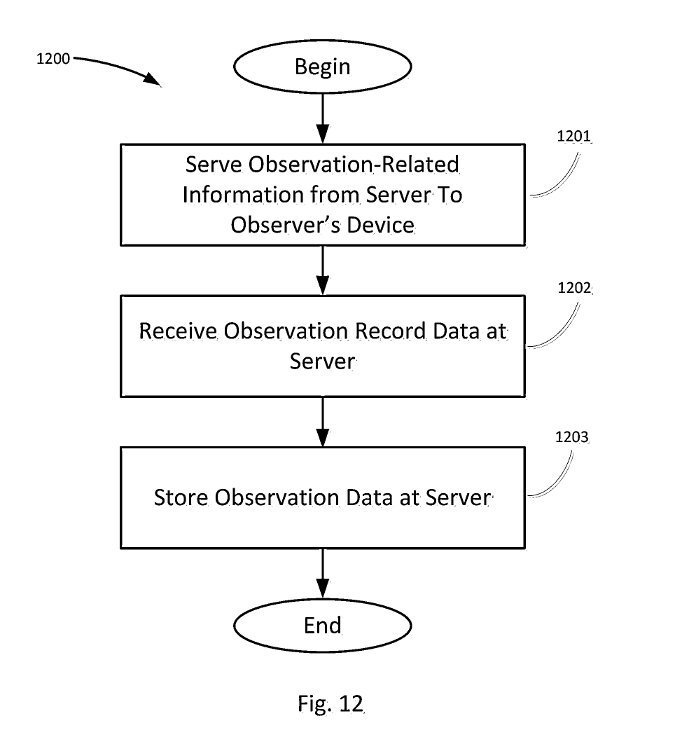

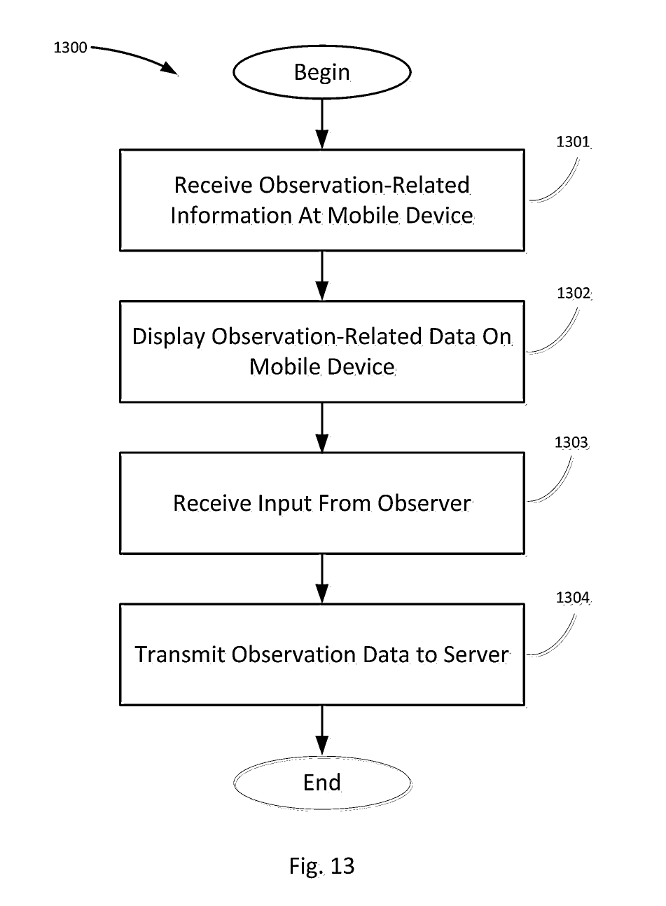

FIG. 12 and FIG. 13 schematically illustrated operations of an observer's mobile data device (e.g., 100) and a server (e.g. 201) over a network (e.g., 202). A process 1200, schematically illustrated by the flow chart in FIG. 12, includes serving data, over a network (e.g., 202), to a mobile computing device (e.g., 100) of the observer, for display on the mobile computing device (step 1201). The data may include, for example, a listing of a set of educators available for observation; a listing of schools having educators available for observation; a listing of a set of templates for use in documenting the observation; a set of content objectives; and a listing of a set of observations in progress, to name but a few examples.

The process 1200 also includes receiving at the server, over the network, from the mobile computing device of the observer, relative to an observation by the observer of an educator selected on the mobile device, and relative to an observation template, observation record data (step 1202). The observation record data may include an observer's selection of educators, schools, templates, and may also include a set of paragraphs or other captured evidence (e.g., photographs, video clips, audio recordings), and alignment data that associates each one of the paragraphs or other observation data with at least one corresponding template standard of the observation template, wherein the alignment data and the observation data have been created by the observer on the observer's mobile computing device.

In addition, the process 1200 also includes storing the observation record data (step 1203). For example, the observation record data may be stored in an observation database (e.g., 1018), wherein the server stores each one of the paragraphs (or other captured evidence) as a comment in association with the at least one corresponding template standard of the observation template as specified by the alignment data.

A process 1300, schematically illustrated by the flow chart in FIG. 13, includes receiving on a mobile device (e.g., 100), over a network, (e.g., 202) from a server (e.g., 201), observation-related information or parameters (step 1301). The information may include, for example, a listing of a set of educators available for observation; a listing of schools having educators available for observation; a listing of a set of templates for use in documenting the observation; a set of content objectives; and a listing of a set of observations in progress, to name but a few examples. Some or all of the observation-related information is displayed (step 1302) to the observer on the mobile device (e.g., 100), to provide to the observer the opportunity to specify observation parameters (step 1303). For example, the method 1300 may include displaying, on the mobile device, a listing of the set of templates, and receiving on the mobile device a selection by the observer of a selected template with respect to which documentation of an observation will be received. As another example, the method 1300 may include displaying on the mobile device the listing of the set of educators, and receiving on the mobile device a selection by the observer of a selected educator with respect to whom documentation of the observation will be received.

The method 1300 also include at step 1303, receiving evidence captured by the observer (e.g., paragraphs, photographs, video clips, audio recordings). In other words, step 1303 may include receiving on the mobile device (e.g., 100) a set of inputs from the observer, relative to the observation by the observer of the selected educator, and relative to an observation template, observation data including a set of paragraphs.

In some embodiments, the method 1300 also includes transmitting the data (e.g., observation parameters; captured evidence) to the server (step 1304) for storage, for example as an observation record stored in a database (e.g., 1018).

Definitions. As used in this description and the accompanying claims, and in addition to terms defined above, the following terms shall have the meanings indicated, unless the context otherwise requires:

A “school administration entity” means any of a school district, a set of school districts sharing administrative functions, an individual school, and a set of individual schools sharing administrative functions.

A “school entity body” is a set of individuals who are stakeholders in the activities of a school administration entity, including administrators, teachers, students, parents of students, and other interest individuals.

An “application” means a computer program or a set of computer programs providing a functionality pertinent to education, wherein the program may be implemented in a server-client context so as to be in the form of Software as a Service (SaaS) or by other means including software that may run on an individual computer.

An item of educational “content” means any digitally storable item that presents information pertinent to education, including in the form of text, pictures, video, audio, or any combination of the foregoing.

An educational “resource” means any of an application, an item of educational content, or a combination of an application with a set of items of educational content.

A “set” includes at least one member.

A “subset” is a proper subset and therefore includes some, but not all, members of a set and also includes at least one member.

A “process” is a set of tasks to be performed by teachers and other educators, established by an administrator, for administrative purposes of a school administration entity, including the observation and evaluation of teachers.

A “computer process” is the performance of a described function in a computer using computer hardware (such as a processor, field-programmable gate array or other electronic combinatorial logic, or similar device), which may be operating under control of software or firmware or a combination of any of these or operating outside control of any of the foregoing. All or part of the described function may be performed by active or passive electronic components, such as transistors or resistors. In using the term “computer process” we do not necessarily require a schedulable entity, or operation of a computer program or a part thereof, although, in some embodiments, a computer process may be implemented by such a schedulable entity, or operation of a computer program or a part thereof. Furthermore, unless the context otherwise requires, a “process” may be implemented using more than one processor or more than one (single- or multi-processor) computer.

A teacher “observation” is a session in which the teacher is observed in teaching by an individual for administrative purposes of a school administration entity. An observation by an observer may be conducted by the observer in the teacher's classroom, or remotely, such as via cameras in the classroom, or via a tele-presence device such as the iRobot Ava 500 tele-presence robot, to name but a few examples.

An “observation record” (or “record of the observation”) is a collection of data and information that define the observation, and may include the parameters of the observation (e.g., identification of the educator; identification of the school; selection of a template; identity of observer; date that observation was initiated; date and time of observation; etc.) as well as captured evidence.

An “observer” is an individual who conducts an observation of a teacher.

A “mobile computing device” is a type of data entry device, and may be a tablet computing platform, or a laptop computer, to name but a few examples.

A “paragraph” is a character string that includes a characterization by the observer of a portion of an observation.

A “template” (or “observation template”) is a collection of template standards (e.g., criteria; which may be defined qualities and/or questions) that define the measures by which an educator is to be assessed or evaluated. Evidence collected by an observer during an observation is later correlated with the template standards, and is ultimately used to assess the degree to which the educator has met the evaluation criteria. For example, in one embodiment reflected in FIG. 8B, template standards may relate to content objectives (e.g., objectives defining the desired content of a class lesson or course), language objectives (e.g., objectives defining terms for which students are responsible), etc. In some embodiments, all templates are specified by third party organizations (e.g., standards bodies; school committees; state secretaries of education, etc.). Some templates may be provided with the system or software that implements the observation environments. In other embodiments, however, at least one template available to the observer may be a custom template defined by the observer (i.e., a user-defined template), or a school administration entity, or a school entity body, or by another stakeholder, or by the observer in conjunction with the educator to be observed, or by any combination of the foregoing people and entities. In a user-defined template, at least some of the template standards are selected by the observer or other entity. User-defined templates may therefore be tailored to fit specific circumstances where a template specified by a third party might be insufficient or inappropriate.

The term “contemporaneous” or “contemporaneously”, when applied to the capture or recording of evidence or data, means that the capture or recording of two or more items of evidence or data occur during the same observation session, but do not necessarily mean that they two items of evidence or data are captured or recorded at the same instant.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods may be implemented as a non-transitory computer program product for use with a computer system. Such implementation may include a series of computer instructions fixed in a non-transitory fashion either on a tangible medium, such as a non-transient computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored, in a non-transitory state, in any non-transitory memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A computer-implemented method of creating documentation of an observation by an observer of an educator, the method comprising:
serving data, over a network, to a mobile computing device of the observer, for display on the mobile computing device, including a listing of a set of educators available for observation and a listing of a set of templates for use in documenting the observation;
receiving at the server, over the network, from the mobile computing device of the observer, relative to an observation by the observer of an educator selected on the mobile device, and relative to an observation template, observation data including a set of paragraphs, and alignment data that associates each one of the paragraphs with at least one corresponding template standard of the observation template, wherein the alignment data and the observation data have been created by the observer on the mobile computing device; and
storing by the server in an observation database the observation data, wherein the server stores each one of the paragraphs as a comment in association with the at least one corresponding template standard of the observation template as specified by the alignment data.

2. The computer-implemented method of claim 1, further comprising receiving at the server over the network, from the mobile computing device of the observer, relative to an observation by the observer of an educator selected on the mobile device, template selection data comprising specification by the observer of an observation template from the set of templates.

3. The computer-implemented method of claim 1, wherein serving data over a network to a mobile computing device further comprises serving data including a listing of a set of observations in progress.

4. The computer-implemented method of claim 3, wherein at least one of the set of observations in progress includes an observation for which at least one observation paragraph has been stored.

5. The computer-implemented method of claim 1, wherein serving data over a network to a mobile computing device further comprises serving data including a listing of schools, wherein at least one of the schools comprises a school at which at least one of the educators is available for observation.

6. The computer-implemented method of claim 1, wherein at least one of the templates listed in the listing of a set of templates is a user-defined template.

7. The computer-implemented method of claim 1, wherein at least one of the templates comprises a plurality of template standards for evaluating a selected educator.

8. The computer-implemented method of claim 7, wherein at least one paragraph of the observation data may be aligned, via the alignment data, with a plurality of the template standards.

9. The computer-implemented method of claim 1, wherein:
the observation data further comprises at least one of audio data, video data, and still-photo data, said audio data, video data, or still-photo data having been captured by the observer contemporaneously with the creation, by the observer on the mobile computing device, of the paragraphs; and
the alignment data further associates the at least one of the audio data, video data, and still-photo data to at least one corresponding template standard of the observation template.

10. The computer-implemented method of claim 9, wherein at least one of the template standards may be associated, at any given time, with at least one of the paragraphs and at least one of the audio data, video data, and still-photo data.

11. The computer-implemented method of claim 1, wherein serving data over a network to a mobile computing device further comprises serving data including content objectives, wherein each content objective includes information describing a corresponding template standard, such that the observer may optionally access a content objective corresponding to a template standard to facilitate generation, by the user, of alignment data between the template standard and one or more of the paragraphs.

12. A computer-implemented method of creating documentation of an observation by an observer of an educator, the method comprising:
receiving on a mobile device, over a network, from a server, a listing of a set of educators available for observation and a listing of a set of templates for use in documenting the observation;
displaying on the mobile device the listing of the set of templates, and receiving on the mobile device a selection by the observer of a selected template with respect to which documentation of an observation will be received;
displaying on the mobile device the listing of the set of educators, and receiving on the mobile device a selection by the observer of a selected educator with respect to whom documentation of the observation will be received; and
receiving on the mobile device a set of inputs from the observer, relative to the observation by the observer of the selected educator, and relative to an observation template, observation data including a set of paragraphs.

13. The computer-implemented method of claim 12, wherein at least one of the templates listed in the set of templates comprises a plurality of template standards for evaluating a selected educator.

14. The computer-implemented method of claim 12, further comprising receiving on the mobile device a set of alignment inputs from the observer, the alignment inputs correlating each paragraph of the observation data to at least one of a plurality of template standards.

15. The computer-implemented method of claim 12, further comprising recording, as a part of the observation data, time and date data corresponding to each of the set of paragraphs of the observation data, each item of the time and date data indicating the time and date of the creation of the corresponding paragraph.

16. The computer-implemented method of claim 12, further comprising communicating the observation data and its corresponding alignment data to the server.

17. The computer-implemented method of claim 12, wherein at least one of the templates from the list of templates comprises a user-defined template.

18. The computer-implemented method of claim 12, wherein the set of inputs from the observer further comprises at least one of audio data, video data, and still-photo data, said audio data, video data, or still-photo data having been captured by the observer contemporaneously with the creation of the paragraphs.

19. The computer-implemented method of claim 12, further comprising receiving on the mobile device, over a network, from the server, a listing of a set of schools, wherein at least one of the schools comprises a school at which at least one of the educators is available for observation.

20. The computer-implemented method of claim 18, wherein at least one of a plurality of template standards may be associated, at any given time, with at least one of the paragraphs and at least one of the audio data, video data, and still-photo data.
